(19) United States
(12) Patent Application Publication
(10) Pub. No.: US 2012/0138638 A1
(43) Pub. Date: Jun. 7, 2012

(54) HAND SOAP DISPENSING SYSTEM FOR PUBLIC WASHROOMS

(76) Inventor: Shiraz F. WALLI, Edmonton (CA)

(21) Appl. No.: 13/305,951

(22) Filed: Nov. 29, 2011

(30) Foreign Application Priority Data
Dec. 3, 2010 (CA) 2 724 145

(51) Int. Cl. B67D 3/00

(52) U.S. Cl. 222/181.3

(57) ABSTRACT

A hand soap dispensing system for public washrooms includes at least one hand soap dispenser installed in a public washroom at a first height and a hand soap reservoir with a capacity to hold sufficient hand soap to supply the at least one hand soap dispenser for more than one day. Hand soap supply lines extend from the hand soap reservoir to the at least one hand soap dispenser. The hand soap reservoir is mounted at a second height that is higher than the first height to create gravity drainage from the hand soap reservoir through the hand soap supply lines to the at least one hand soap dispenser.

### FIELD

There is described a hand soap dispensing system for large public washrooms that reduces the workload for washroom attendants.

### BACKGROUND

Large public buildings have large public washrooms with three or more toilets and an equal or greater number of sinks. Some public buildings, such as airports, have heavy usage of their washrooms due to the volume of people passing through the facility. It is, therefore, the policy of each airport to assign a staff member to check on each washroom on a regular basis throughout the day (usually hourly) to ensure that there is an adequate supply of paper towels, toilet paper, and hand soap. The staff member must also check the cleanliness of the washroom, ensure that all sinks and toilets are functioning and there are no potential slip and fall hazards, such as puddles of water on the floor. Where there are a large number of washrooms, it is difficult to maintain the maintenance schedule, especially when problems are encountered with one or more of the washrooms. What is required are ways of reducing the number of tasks to be performed by washroom attendants during their regular washroom checks.

### SUMMARY

There is provided a hand soap dispensing system for public washrooms, which includes at least one hand soap dispenser installed in a public washroom at a first height. A hand soap reservoir with a capacity to hold sufficient hand soap to supply the at least one hand soap dispenser for more than one day is provided. Hand soap supply lines extend from the hand soap reservoir to the at least one hand soap dispenser. The hand soap reservoir is mounted at a second height that is higher than the first height to create gravity drainage from the hand soap reservoir through the hand soap supply lines to the hand soap dispensers.

With the hand soap dispensing system, as described above, the level of the hand soap reservoir need only be checked once a day. As the hand soap reservoir holds more soap than will be used in one day, there is no danger of the hand soap dispensers running out of hand soap.

The number of hand soap dispensing systems may be changed to accommodate different sized washrooms with different numbers of sinks and stalls. The hand soap dispensing system is particularly beneficial when a washroom has three or more dispensers.

Most large public washroom have an associated maintenance room or a pipe chase that allows tradesmen access to piping. If desired, the hand soap reservoir may be mounted in the maintenance room or pipe chase area, where it is not visible to or accessible by users of the public washroom. In such a case, the hand soap supply lines will extend through a wall of the public washroom to the hand soap dispensers. As the hand soap reservoir is not visible, this provides a more aesthetically appealing appearance within the washroom. As the hand soap reservoir is not accessible to users of the washroom, this prevents tampering by vandals.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a hand soap dispensing system for public washrooms.

FIG. 2 is a top plan view of the hand soap dispensing system for public washrooms shown in FIG. 1.

### DETAILED DESCRIPTION

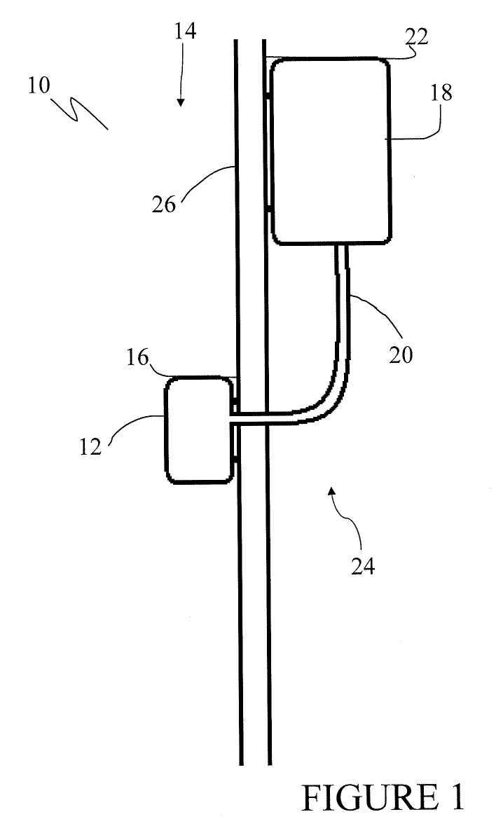

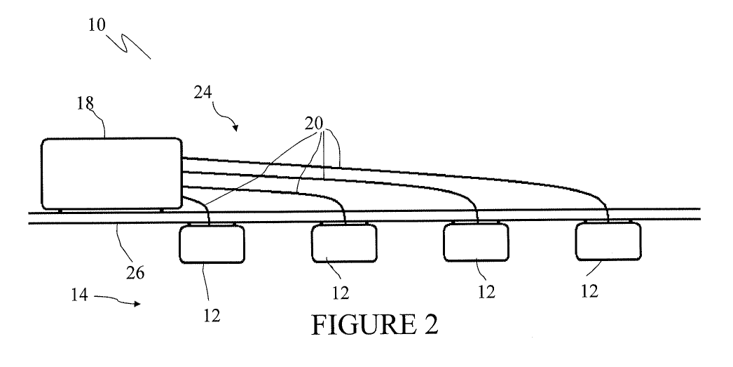

A hand soap dispensing system for public washrooms generally identified by reference numeral 10, will now be described with reference to FIG. 1 through 2.

Structure and Relationship of Parts:

Referring to FIG. 1, a hand soap dispensing system for public washrooms 10 includes hand soap dispensers 12 installed in a public washroom 14 at a first height 16 and a hand soap reservoir 18 with a capacity to hold sufficient hand soap to supply hand soap dispensers 12 for more than one day. Soap reservoir 18 is preferably a reservoir that is replenished using bulk soap, rather than using cartridges. In this example, soap reservoir is preferably air tight to avoid deterioration of the soap that may occur after prolonged exposure to oxygen. This may require a release valve in order to avoid a vacuum being formed and preventing the flow of soap from reservoir 18. Referring to FIG. 2, in the embodiment shown there are four hand soap dispensers 12, however it will be understood that more or fewer hand soap dispensers 12 may be utilized. Hand soap supply lines 20 extend from hand soap reservoir 18 to hand soap dispensers 12. Referring to FIG. 1, hand soap reservoir 18 is mounted at a second height 22 that is higher than first height 16 to create gravity drainage from hand soap reservoir 18 through hand soap supply lines 20 to hand soap dispensers 12.

As can be seen, supply lines 20 are fed from the bottom of soap reservoir 18. Supply lines 20 may also be fed from a lower portion of soap reservoir 18, however this may prevent all the soap from draining.

Hand soap reservoir 18 may be mounted in a maintenance room or pipe chase 24 where it is not visible to or accessible by users of public washroom 14. Hand soap supply lines 20 would extend through a wall 26 of public washroom 14 to hand soap dispensers 12.

### Operation:

Referring to FIG. 1, hand soap dispensing system for public washrooms 10 is installed in a public washroom 14 by installing hand soap dispensers 12 on wall 26 at a first height 16. Hand soap dispensers 12 may be attached to wall 26 by screws, brackets or any other item or material suitable for the installation. Hand soap reservoir 18 is installed on wall 26 at a second height 22 to allow gravity drainage from hand soap reservoir 18 to hand soap dispensers 12 to occur. In the embodiment shown, hand soap reservoir 18 is mounted in a maintenance room 24 adjacent public washroom 14, however it will be understood that hand soap reservoir 18 may also be placed in public washroom 14. Soap supply lines 20 fluidly connect hand soap reservoir 18 to hand soap dispensers 12. Hand soap reservoir 18 is large enough to contain more than one days worth of soap and provides continual refilling of hand soap dispensers 12 as soap is utilized.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A hand soap dispensing system for public washrooms, comprising:
at least one hand soap dispenser installed in a public washroom at a first height;
a hand soap reservoir with a capacity to hold sufficient hand soap to supply the at least one hand soap dispenser for more than one day;
hand soap supply lines extending from the hand soap reservoir to the at least one hand soap dispenser; and
the hand soap reservoir being mounted at a second height that is higher than the first height to create gravity drainage from the hand soap reservoir through the hand soap supply lines to the at least one hand soap dispenser.

2. The hand soap dispensing system of claim 1, wherein the hand soap reservoir is mounted in a maintenance room or pipe chase where it is not visible to or accessible by users of the public washroom and the hand soap supply lines extend through a wall of the public washroom to the hand soap dispensers.

3. The hand soap dispensing system of claim 1, wherein there are three or more hand soap dispensers.
